(19) United States
(12) Patent Application Publication
(10) Pub. No.: US 2018/0273352 A1
(43) Pub. Date: Sep. 27, 2018

(54) SEQUENTIAL PIGGYBACK CYLINDERS FOR EXTENDABLE BOOM CRANE

(71) Applicant: Wetherell Mfg Co., Cleghorn, IA (US)

(72) Inventors: TODD WETHERELL, CLEGHORN, IA (US); JAMES CASEY, SPENCER, IA (US)

(21) Appl. No.: 15/799,028

(22) Filed: Oct. 31, 2017

Related U.S. Application Data
(60) Provisional application No. 62/474,840, filed on Mar. 22, 2017.

(51) Int. Cl. B66C 23/70; B66C 13/16; B66C 23/00

(52) U.S. Cl. CPC B66C 23/705; B66C 23/54; B66C 13/16

(57) ABSTRACT

A crane boom has three telescoping sections which move consistently in a sequential pattern between extended and retracted positions. When extending, the outer section moves first, followed by the middle section. When retracting, the middle section moves first, followed by the outer section. A pair of hydraulic actuators with a series of valves control the extension and retraction of the outer and middle boom sections.

### CROSS-REFERENCE TO RELATED APPLICATIONS

This application claims priority to Provisional Application U.S. Ser. No. 62/474,840, filed on Mar. 22, 2017, which is herein incorporated by reference in its entirety.

### BACKGROUND OF THE INVENTIONS

Conventional cranes utilize a three-part boom having a base section, a middle or intermediate section, and an outer or stinger section. The boom sections are extended by a pair of hydraulic cylinders. As the sections extend further, the lifting compacity of the crane is decreased due to the length of the lifting arm.

More particularly, as shown in FIGS. 1-3, a conventional boom crane 110 includes a base section 112, a middle section 114, and an outer section or stinger 116. Extension and retraction of the middle section 114 is controlled by a hydraulic cylinder 118. Extension and retraction of the outer section 116 is controlled by a hydraulic cylinder 120. The cylinders 118, 120 are arranged side by side, commonly known as a piggyback orientation, with the rods 122, 124 of each cylinder 118, 120 respectively, extending in opposite directions. A first hydraulic fluid line 126 supplies hydraulic fluid to the cylinders 118, 120 to extend the cylinders. A second fluid line 128 retracts the cylinders 118, 120. The conventional prior art boom 110 has a valve block 130 adjacent the base 112, with an extend port 132 and a retract port 134, also including counter balance valves CB1 and CB2. A control valve 152 controls flow of the hydraulic fluid to and from the cylinders 118, 120. During extension of the boom 110, the hydraulic fluid or oil follows the path of least resistance, causes cylinders 118 and 120 to extend in unpredictable fashion. Thus, the middle section 114 and outer section 116 do not move sequentially, but rather move randomly when extending and retracting. Thus, precision extension and retraction is difficult for an operator. Also, since the middle and outer section 114, 116 do not extend and retract in the same sequence each time, it is difficult for the operator to control the lifting capacity of the boom.

Therefore, there is a need for an improved hydraulic system for a boom on cranes and similar equipment.

Accordingly, an objective of the present invention is the provision of a crane or lifting boom with extendable and retractable sections and having sequentially operated piggyback cylinders without the addition of flexible external hydraulic fluid lines, and which provide visual indicia for the position of the boom sections.

A further objective of the present invention is the provision of an improved hydraulic system for extendable and retractable booms which assures that the outer boom section extends first, and that the middle boom section retracts first.

Still another objective is the provision of an improved extendable and retractable boom having lifting capacities which are easy to determine.

Yet another objective is the provision of an improved extendable and retractable boom having consistent extension and retraction of boom sections.

A further objective of the present invention is the provision of a boom which can be extended and retracted with controlled accuracy.

Another objective of the present invention is the provision of a boom whose lifting limits can be visually ascertained during extension of the boom sections.

Another objective of the present invention is the provision of a boom having indicia for determining the lift load during extension of the boom sections.

Another objective of the present invention is the provision of a hydraulic system for extendable and retractable booms which is economical to manufacturers, easy to operate, and durable in use.

These and other objectives become apparent from the following description of the invention.

### SUMMARY OF THE INVENTION

A boom for a crane and other lifting operations includes a base section, a middle section, and an outer or stinger section. The outer section is extendable and retractable relative to the middle section, and the middle section is extendable and retractable relative to the base section. Movement of the outer and middle sections is achieved via a pair of piggyback hydraulic cylinders and a pair of hydraulic fluid lines, with valves in the lines to control the movement of the sections. The valves assure that the outer section always extends first before extension of the middle section and assures that the middle section always retracts first before retraction of the outer section. With this controlled, sequential movement of the boom sections, the lifting compacity of the boom is easily known or calculated. Indicia on the middle and outer sections provide a quick and easy visual indication of the extent or degree of extension and/or retraction of the middle section and outer stinger section of the boom. These indicia or markings allow the boom operator to safely operate the crane without exceeding load capacities of the boom, since the middle and outer sections extend and retract in the same order each time.

### BRIEF DESCRIPTION OF THE DRAWINGS

FIG. 1 is a side elevation view of a conventional boom crane in a partially extended condition.

FIG. 2 is a fluid schematic for the boom shown in FIG. 1.

FIG. 3 is another fluid flow diagram for the boom shown in FIG. 1.

FIG. 4 is a side elevation view of a boom crane having the hydraulic system of the present invention, with the outer section extended.

FIG. 5 is a fluid flow schematic for the boom shown in FIG. 4.

FIG. 6 is another fluid flow diagram for the boom shown in FIG. 4.

FIG. 7 is a fluid flow schematic for the boom of FIG. 4 with the intermediate section partially extended.

FIG. 8 is an enlarged view taken along lines 8-8 of FIG. 7.

FIG. 9 is a fluid flow diagram corresponding to FIG. 7.

FIG. 10 is a side elevation view of a boom crane having a hydraulic system of the present invention showing the middle boom section extended further than shown in FIG. 7.

FIG. 11 is a fluid flow schematic for the boom shown in FIG. 10.

FIG. 12 is another fluid flow diagram corresponding to FIG. 11.

FIG. 13 is a side elevation view of the boom crane with the middle and outer sections fully extended but starting to retract, in accordance with the present invention.

FIG. 14 is a fluid flow schematic for the boom shown in FIG. 13.

FIG. 15 is a fluid flow diagram corresponding to FIG. 14.

FIG. 16 is a side elevation view of the boom with the middle section fully retracted and the outer section fully extended but starting to retract.

FIG. 17 is a fluid flow schematic for the boom shown in FIG. 16.

FIG. 18 is a fluid flow diagram corresponding to FIG. 17.

FIG. 19 is a side elevation view showing the boom crane and corresponding cylinders in a fully retracted position.

FIG. 20 is a view showing the outer section stinger of the boom crane fully extended and the indicia for cylinder positions.

FIG. 21 is a view showing the boom outer and intermediate sections fully extended, and the indicia cylinder positions.

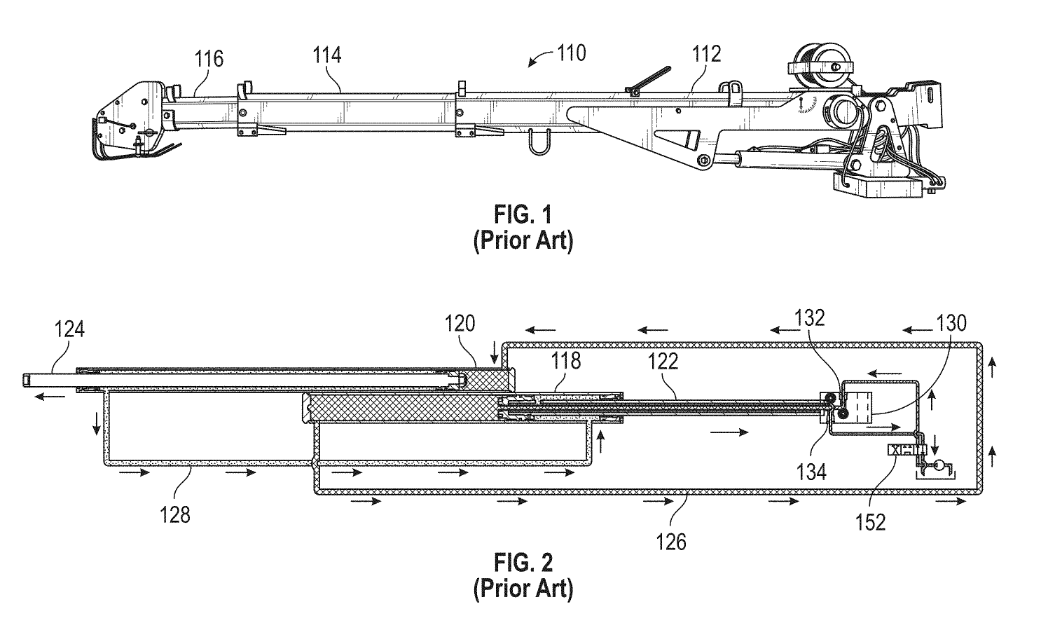

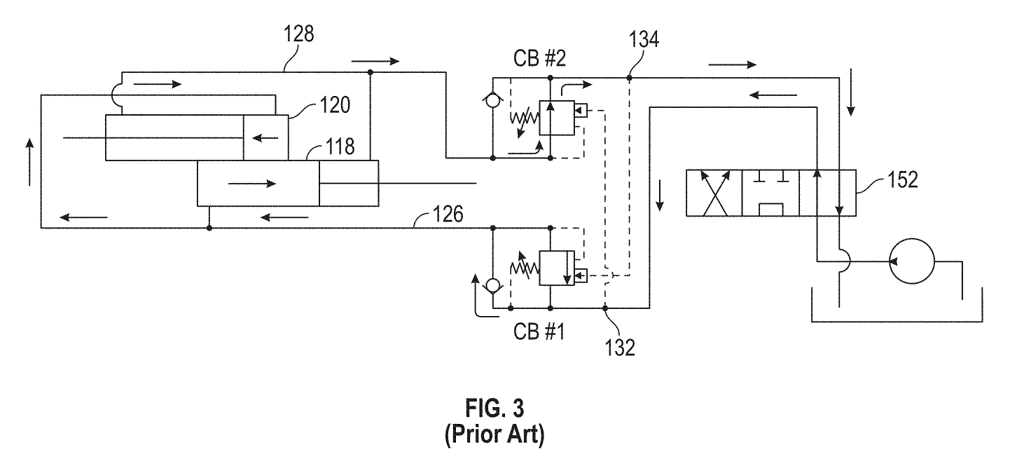

### DETAILED DESCRIPTION OF THE INVENTION

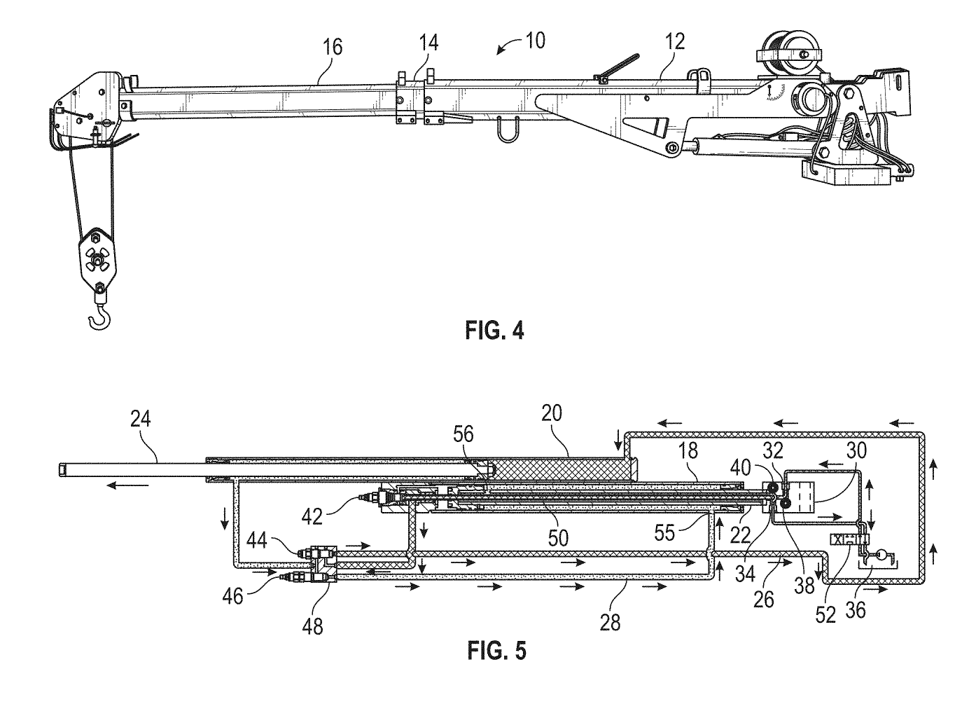

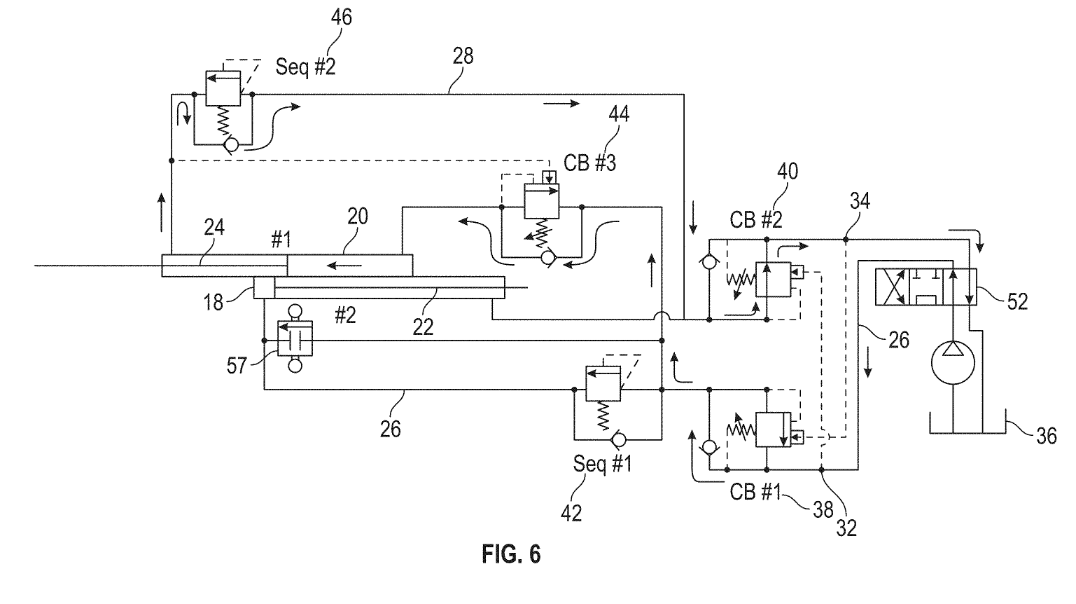

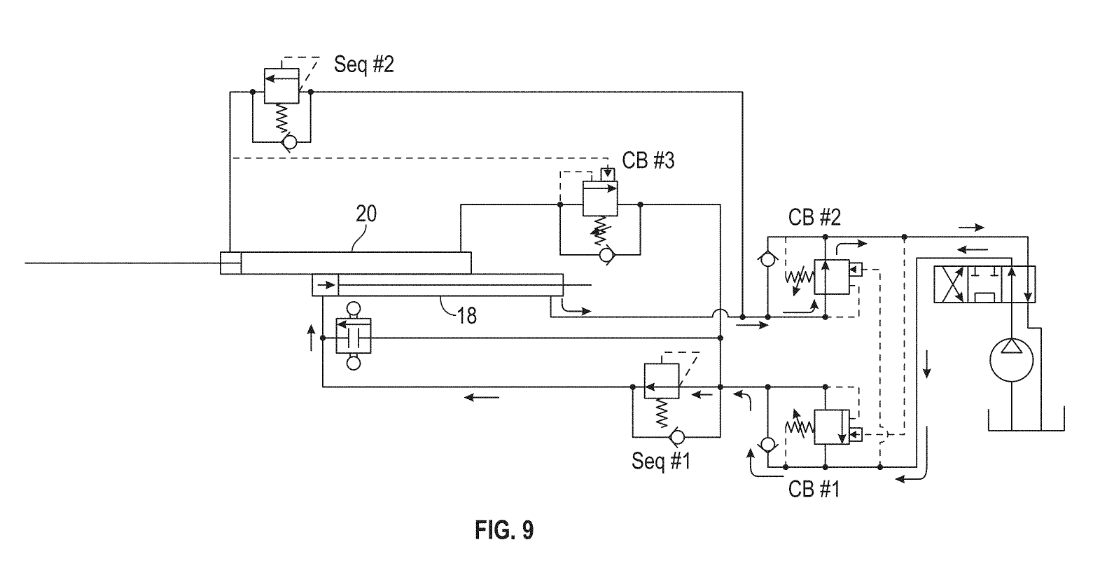

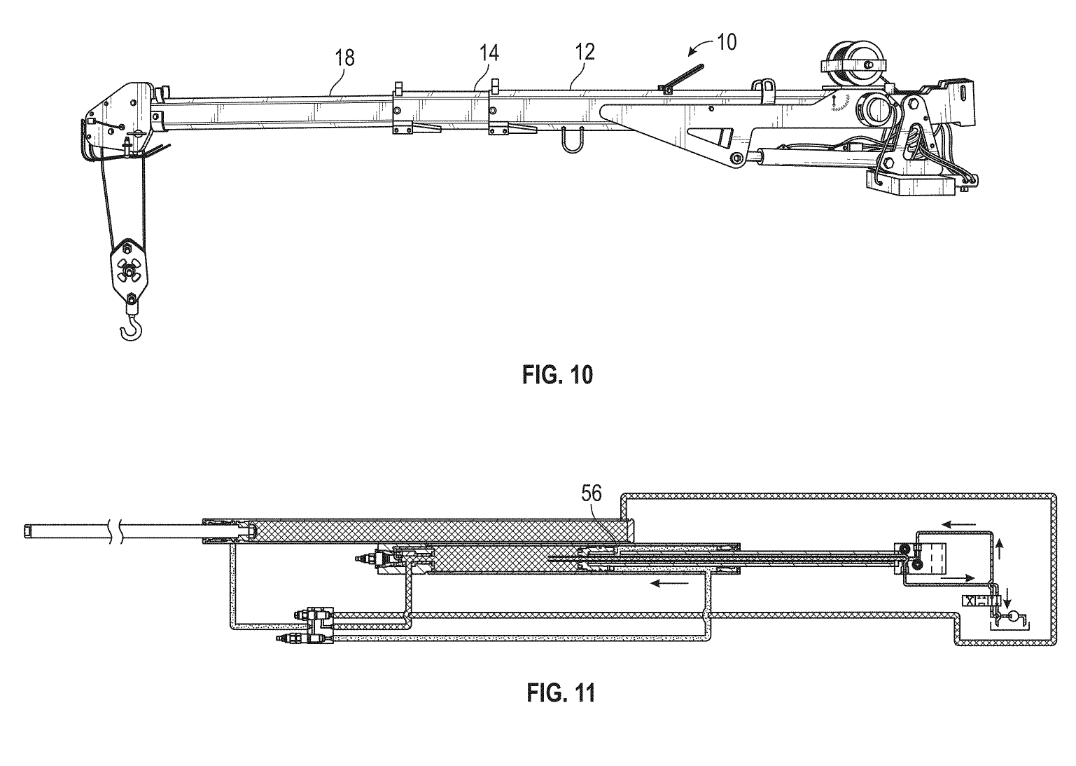

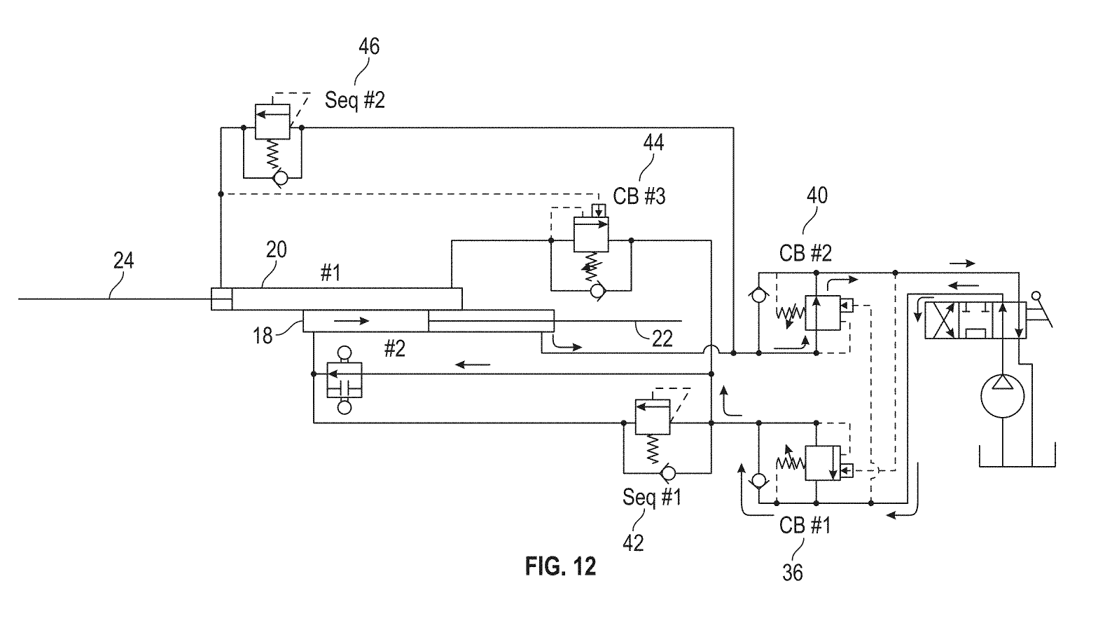

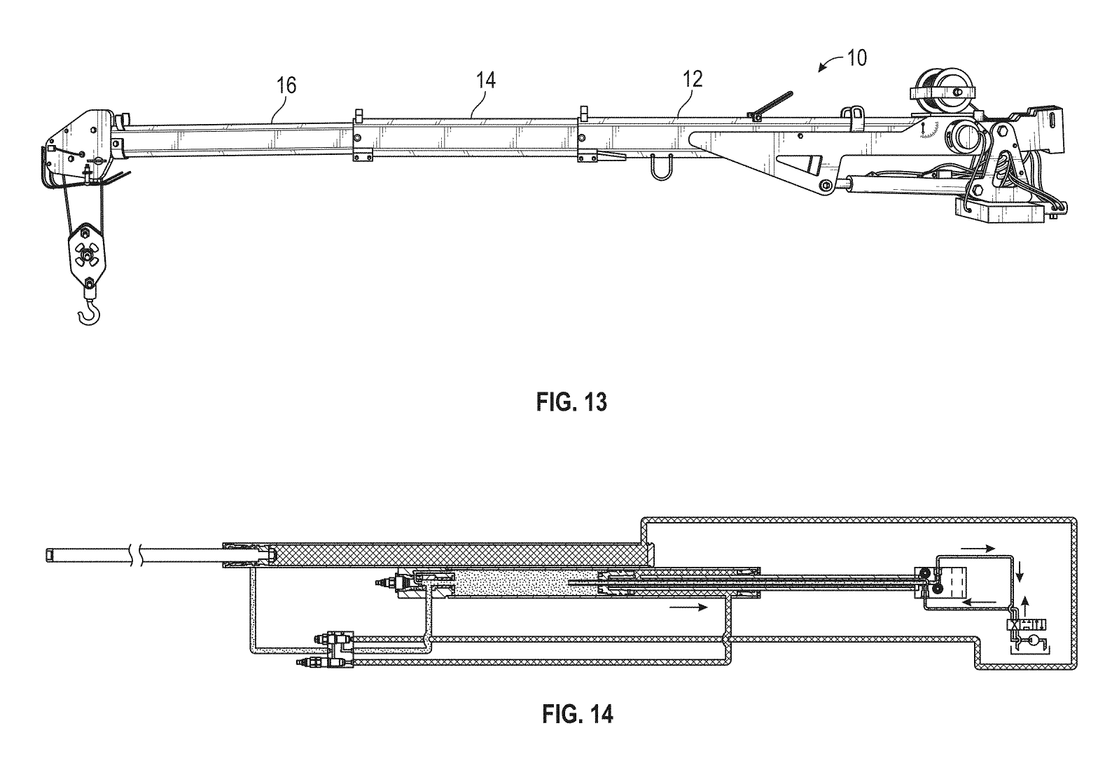

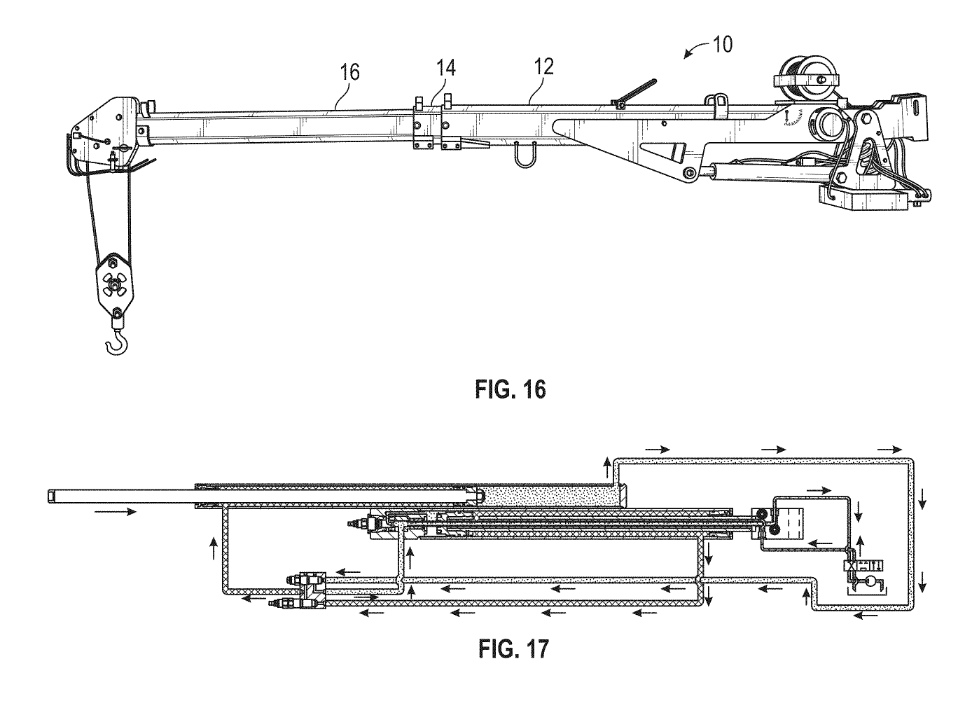

The invention is shown in FIGS. 4-21. The boom 10 of the invention includes a base section 12, and an extendable and retractable middle section 14, and an extendable and retractable outer or stinger section 16.

The boom 10 also includes a pair of piggy back, side by side hydraulic cylinders 18, 20 for moving the middle and outer sections 14, 16, respectively. The cylinder 18 includes a rod 22 and a center tube 50, and the cylinder 20 includes a rod 24. The cylinders 18 and 20 are oriented opposite one another such that the rods 22, 24 extend in opposite directions. A first hydraulic fluid line 26 controls extension of the cylinders 18, 20. A second hydraulic fluid line 28 controls retraction of the cylinders 18, 20.

The hydraulic system of the present invention includes a control valve 52 with an extension port 32 and a retraction port 34. The valve 52 and ports 32, 34 are fluidly coupled to a hydraulic fluid reservoir 36. A valve block 30 includes a first counter balance valve 38 in the extension line 26 and a second counter balance 40 valve in the retraction line 28. A first sequencing valve 42 is provided in the cylinder 18 and fluidly coupled to the extension line 26. A third counter balance valve 44 is fluidly connected in the extension line 26. A second sequencing valve 46 is fluidly connected in the retraction line 28. The counter balance valve 44 and sequencing valve 46 may be provided in a valve body 48 mounted or attached to the case of cylinder 20.

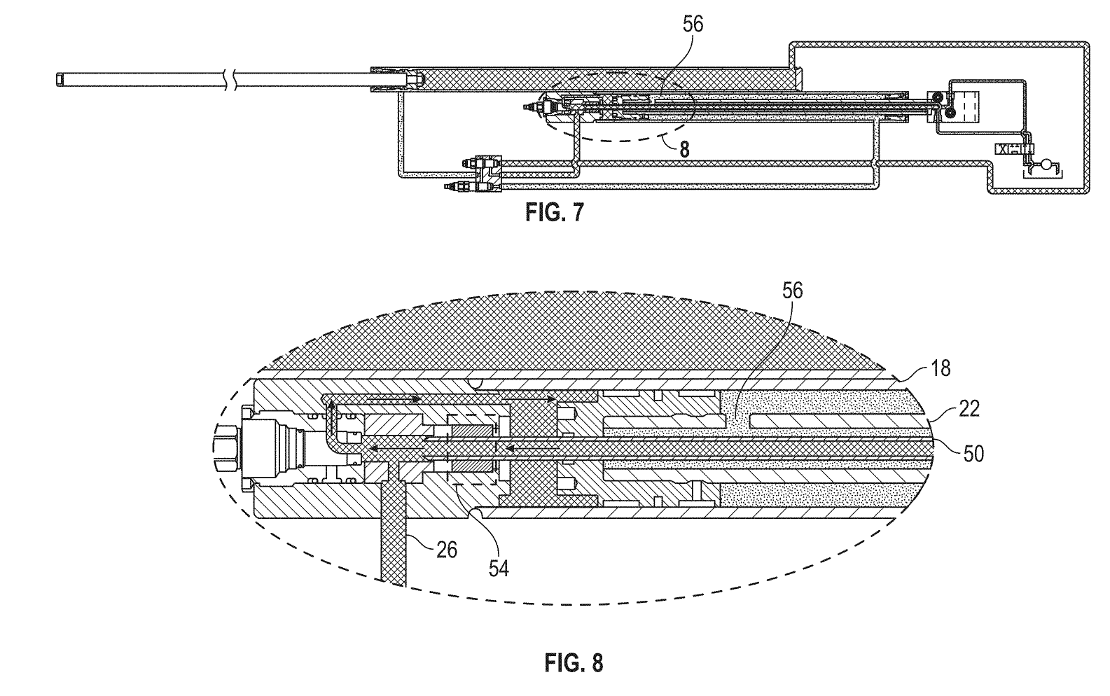

In operation, when the boom sections 14, 16 are fully retracted and ready for extension, the control valve 52 provides hydraulic fluid flow to the extension port 32 at the end of the base section 12. The fluid, such as all, flows through the tube 50 in rod 22, then through porting in a butt plate of the cylinder 18, and then through the check function of the third counter balance valve 44, and then on to the outer cylinder 20. The hydraulic fluid or oil is prevented from extending the cylinder 18 by the first sequencing valve 42. Return fluid or oil from the rod side of cylinder 20 passes through the check function of the second sequence valve 46, into a radial hole 55 near the head of the cylinder 18, and then back through the retract port 34 of the valve block 30. This fluid flow causes the outer section 16 to extend before any extension of the middle section 14. After the cylinder 20 is fully extended such that the stinger 16 is fully extended, the control valve 52 remains in the extend position, and the supply fluid pressure increases so as to open the first sequence valve 42. This fluid flow causes the cylinder 18 to extend the middle section 14 of the boom 10, as shown in FIGS. 7-9. To continue the extension of the middle section 14, after the cylinder 18 initially extends approximately 1¼ inch, the center tube 50 of the rod 22 withdraws from the seal 54 and the first sequence valve 42 closes, so that fluid pressure is supplied equally to the extension side of both cylinders 18, 20. The cylinder 20 is prevented from retracting by the counter balance valve 44. Return fluid or oil from the rod side of the cylinder 18 passes through a radial hole 56 in the rod 22 and back through the retract port 34 of the valve block 30. This fluid flow is illustrated in FIG. 11, 12.

Item 57 represents function when tube 50 is inserted into the seal 54 (blocked flow) and retracted from the seal 54 (free flow).

Thus, the cylinder 20 and the outer boom section 16 extend first and fully before any extension of the cylinder 18 and the middle boom section 14. When it is time to retract the boom, the process is reversed, such that the cylinder 18 and middle section 14 retract first and fully before retraction of the cylinder 20 and outer boom section 16.

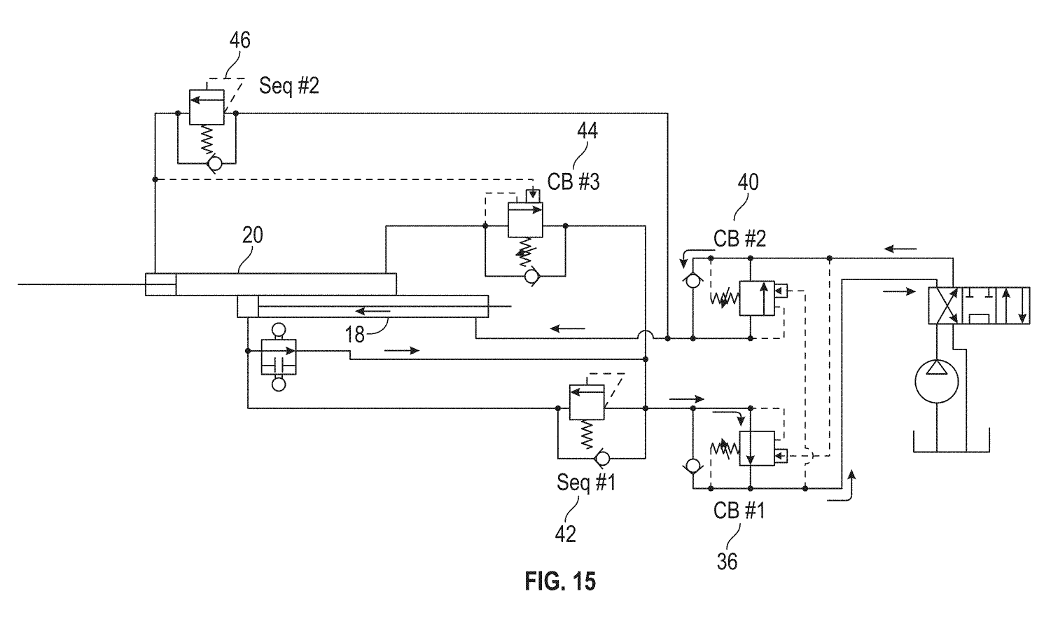

More particularly, when the control valve 52 is moved to the retract position, the fluid flow is directed through the retract port 34 and into the rod 22 of the cylinder 18, and exits through the radial hole 56 in the rod so as to cause the cylinder 18 to retract. The fluid is prevented from retracting cylinder 20 by the second sequence valve 46. Return fluid or oil from the butt plate side of the cylinder 18 initially passes through the open end of the center tube 50. During the last approximately 1¼ inch travel of the tube 50, the tube seals again, such that fluid then passes through the check function of the first sequence valve 42, and then through the inner tube 50 of the rod 22 and back to the extend port 32 of the valve block 30. This fluid flow is shown in FIGS. 14 and 15.

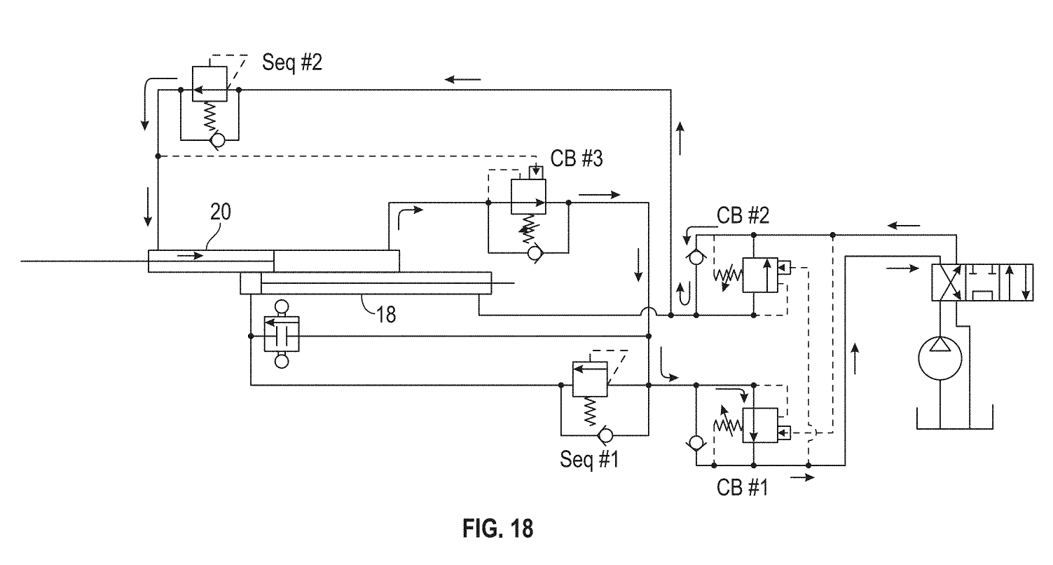

The control valve 52 remains in the retract position. When the cylinder 18 is fully retracted, the supply pressure rises to open the sequence valve 46, which directs fluid or oil to a port at the rod end of the cylinder 20. Return fluid goes through the counter balance valve 44 which is opened by pilot pressure downstream of the sequence valve 46. This fluid flow is shown in FIGS. 17 and 18.

It is understood that the bores and rods of hydraulic cylinders 18, 20 may be identical diameters (in which case, the counter-balance valves may be eliminated), or may have different bore or rods sizes. Also, there may be additional single or piggyback cylinders in series, beyond the pair described above.

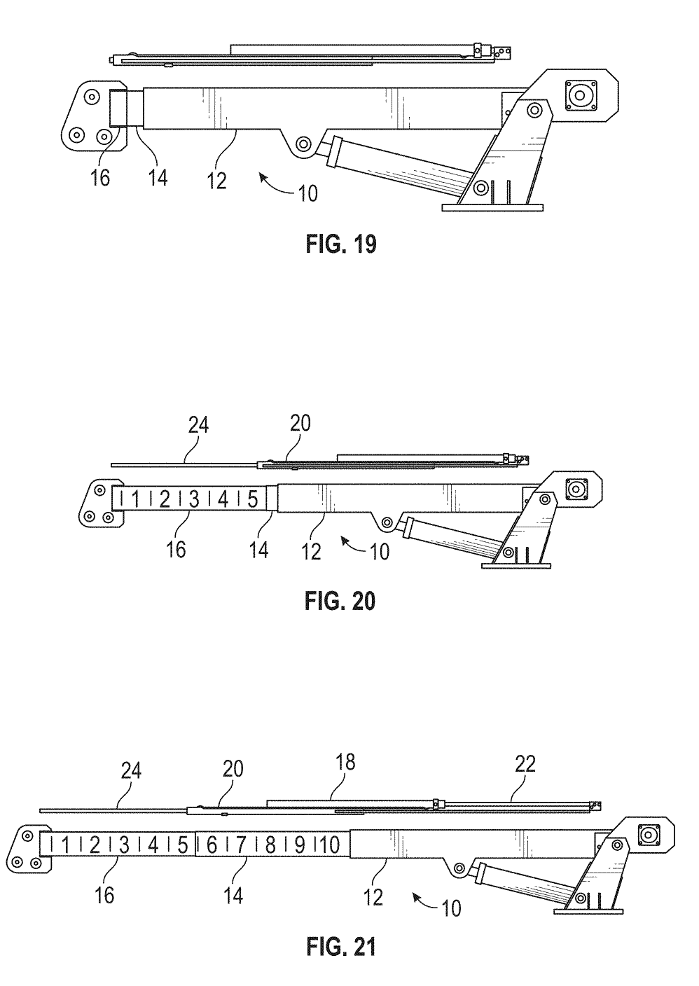

In addition to the improved hydraulic system for the boom 10, the present invention provides visual indicia to the boom operator corresponding to the extension and retraction positions of the middle section 14 and outer stinger section 16. As seen in FIG. 19, the indicia are not visible when the boom 10 is fully retracted. As seen in FIGS. 20 and 21, the indicia begin on the outer stinger section 16 and progress toward and on the middle section 14. These indicia allow the operator to safely operate the boom without exceeding load capacities as the boom sections extend or retract. Such indicia cannot be used on the conventional boom 110, since the middle and outer sections 114, 116 do not extend sequentially, but rather in an unpredictable or inconsistent order.

From the foregoing, it can be seen that the present invention accomplishes at least all of its stated objectives.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A boom, comprising:
a base section;
a middle section mounted to the base;
an outer section mounted to the middle section;
a first hydraulic cylinder inside the outer section to extend and retract the outer section relative to the middle section;
a second hydraulic cylinder inside the middle section to extend and retract the middle section relative to the base section;
the first and second cylinders being side by side and oriented in opposite directions;
a first hydraulic line to supply fluid from the first cylinder to the second hydraulic cylinder;
a second hydraulic line to supply fluid from the second cylinder to the first cylinder;
a first valve in the first line to control fluid flow;
a second valve in the second line to control fluid flow;
wherein the valves cause the first hydraulic cylinder to extend before the second hydraulic cylinder extends and cause the second hydraulic cylinder to retract before the first hydraulic cylinder retracts.

2. The boom of claim 1 further comprising a third valve in the second hydraulic line to further control fluid flow.

3. The boom of claim 1 wherein further comprising a third valve is a sequencing valve.

4. The boom of claim 1 wherein the first valve is a counter balance valve.

5. The boom of claim 1 wherein the second valve is a sequencing valve.

6. The boom of claim 1 wherein the first and second hydraulic cylinders extend internally within the middle and outer sections.

7. The boom of claim 1 further comprising indicia on the middle and outer sections to provide a visible measurement of extension and retraction of the sections.

8. The boom of claim 1 wherein the first and second hydraulic cylinders are free from flexible fluid lines.

9. A lifting boom, comprising:
base, outer, and middle telescoping sections;
a first actuator to extend and retract the outer section relative to the middle section;
a second actuator to extend and retract the middle section relative to the base section;
a fluid controller connected to the actuators to sequentially extend the outer section and then the middle section, and to sequentially retract the middle section and then the outer section.

10. The lifting boom of claim 9 wherein the actuators are first and second hydraulic cylinders.

11. The lifting boom of claim 10 wherein the hydraulic cylinders extend within the middle and outer sections.

12. The lifting boom of claim 10 wherein the hydraulic cylinders are free from flexible fluid lines.

13. The lifting boom of claim 10 wherein the hydraulic cylinders are side-by-side.

14. The lifting boom of claim 10 wherein the hydraulic cylinders are arranged in piggyback fashion.

15. The lifting boom of claim 10 wherein the hydraulic cylinders extend in opposite directions from one another.

16. The lifting boom of claim 10 wherein the actuators further include a first fluid line providing fluid flow from the first hydraulic cylinder to the second hydraulic cylinder, and a second fluid line providing fluid flow from the second hydraulic cylinder to the first hydraulic cylinder.

17. The lifting boom of claim 16 wherein the fluid controller includes first and second valves in the first and second fluid lines, respectively, to control fluid flow through the fluid lines.

18. A method of extending and retracting a boom having base, outer and middle telescoping sections comprising:
extending an outer boom section first; then
extending the middle boom section; then
retracting the middle boom section; and then
retracting the outer boom section.

19. The method of claim 18 further comprising using hydraulics to extend and retract the outer and middle booms.

20. The method of claim 19 further comprising controlling extension and retraction of the outer and middle sections via a plurality of values in hydraulic fluid lines.
